(19) United States
(12) Patent Application Publication
(10) Pub. No.: US 2010/0277781 A1
(43) Pub. Date: Nov. 4, 2010

(54) ROTATING MIRRORED STILE FOR USAGE WITHIN A MIRROR LABYRINTH

(76) Inventor: Darrin Elias, Troy, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/705,047

(22) Filed: Feb. 12, 2010

Related U.S. Application Data
(63) Continuation-in-part of application No. 12/434,345, filed on May 1, 2009.

(51) Int. Cl. G02B 26/12; G02B 26/08

(52) U.S. Cl. 359/201.2; 359/212.2; 359/205.1

(57) ABSTRACT

A winged rotatable mirrored stile is provided having a post mounted to define a vertical rotational axis in a mirror labyrinth. A plurality of wings extends radially from the post with each of the wings, at least one wing face supporting a mirror.

A mirror labyrinth is provided that includes multiple fixed position interreflective mirrors and a rotatable mirrored stile sharing reflections with the multiple fixed position interreflective mirrors to enhance the disorienting and therefore amusement value of the labyrinth.

### CROSS-REFERENCE TO RELATED APPLICATION

This application is a continuation-in-part of U.S. patent application Ser. No. 12/434,345 filed May 1, 2009, the contents of which are incorporated herein by reference.

### FIELD OF THE INVENTION

The present invention in general relates to a rotating mirrored stile and in particular to a motorized rotating mirrored stile incorporated into a mirror labyrinth in order to enhance the visual complexity associated with navigating the mirror labyrinth.

### BACKGROUND OF THE INVENTION

A mirror labyrinth represents a source of amusement associated with the visual disorientation created by multiple reflections between mirrors within the labyrinth. These multiple reflections not only create a perception of an infinite repeating space, but also can be constructed to obscure a portal within the labyrinth and a mirror surface. The visual trickery creates a sense of amusement; however, as one navigates a mirror labyrinth, visual perception becomes heightened to successfully navigate the labyrinth and distinguish between portals through which a user can pass from a mirrored surface. With experiential training, mirror labyrinth navigation becomes easier thereby diminishing the amusement value. Prior art attempts to increase the optical illusion associated with a mirror labyrinth have included mounting of clear glass or polymeric panes in lieu of a mirror or the inclusion of floor lighting as detailed in US 2008/0205046 A1. While these improvements have proved somewhat successful, the resultant mirror labyrinth remains static with respect to multiple reflections between mirrors.

Thus, there exists a need for a rotating mirrored stile to create dynamic interreflective mirrors. There further exists a need for a rotating mirrored stile to be motor driven so as to afford a dynamic mirror labyrinth.

### SUMMARY OF THE INVENTION

A winged rotatable mirrored stile is provided having a post mounted to define a vertical rotational axis in a mirror labyrinth. A plurality of wings extends radially from the post with each of the wings, at least one wing face supporting a mirror.

A mirror labyrinth is provided that includes multiple fixed position interreflective mirrors and a rotatable mirrored stile sharing reflections with the multiple fixed position interreflective mirrors to enhance the disorienting and therefore amusement value of the labyrinth.

### BRIEF DESCRIPTION OF THE DRAWINGS

FIG. 1 is an exploded view of an inventive rotating mirrored stile;

FIG. 2 is an exploded view of an alternate pentagonal mirrored post depicting a distorting, nonplanar mirror;

FIG. 3 is a top view of an exemplary mirror labyrinth including an inventive mirrored stile;

FIG. 4 is a perspective view of an inventive rotating winged mirrored stile; and

FIG. 5 is a top view of an alternative exemplary mirror labyrinth including an inventive mirrored stile.

### DETAILED DESCRIPTION OF THE PREFERRED EMBODIMENTS

The present invention has utility in increasing visual illusion associated with a user navigating a mirror maze. Through the inclusion of a rotatable mirrored stile within a mirror labyrinth, the image interreflection associated with a mirror labyrinth is dynamic as the mirrored stile rotates. Preferably, the rotatable mirrored stile has a motor drive mechanism which during activation creates a dynamic interreflective illusion. The drive mechanism is optionally activated upon sensing a person in proximity to the rotatable mirrored stile.

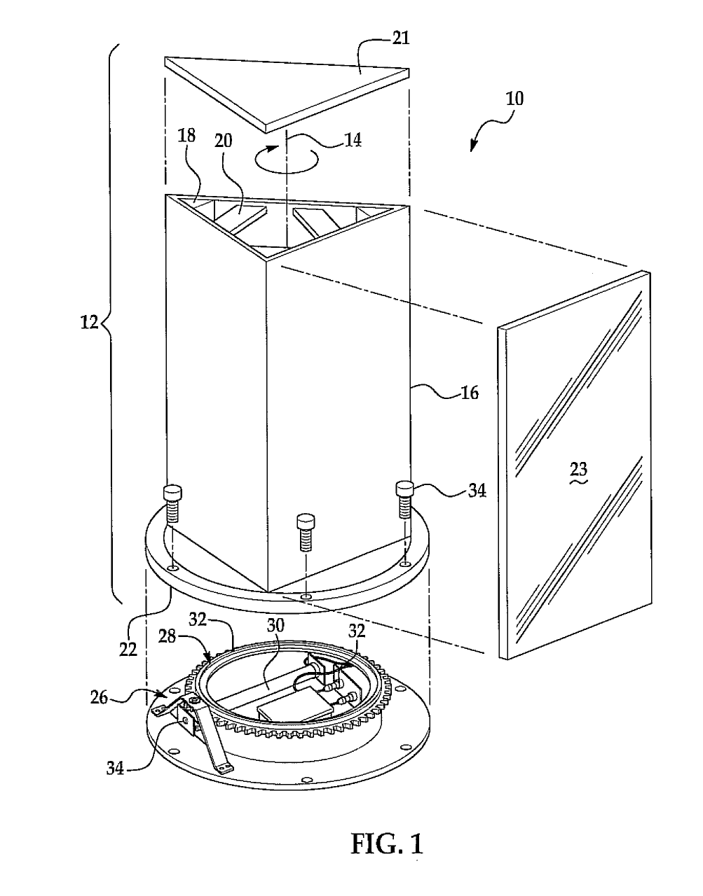

The present invention will be further detailed with respect to the following nonlimiting figures. Referring now to FIG. 1, an inventive rotatable mirrored stile is shown generally at 10. The stile 10 includes a polygonal post 12 rotatable about a vertical axis 14. The post 12 has two to eight rotationally degenerate faces 16 relative to the rotational axis 14. In the instance when post 12 has two rotationally degenerate faces, the post is actually quadrangular in top view with two opposing faces with a long linear extent relative to the two intermediate adjoining faces. The polygonal post 12 depicted in FIG. 1 is triangular with three rotationally degenerate faces 16. Preferably, a triangular post is formed as approximately an equilateral triangle when viewed from above. It is appreciated that an equilateral triangle has a high degree of symmetry and therefore has a larger number of points of interreflective overlap with a surrounding mirror labyrinth upon rotation about the axis 14. A post 12 is formed by joining sheets of material such as sheet metal, plywood, or mirrored sheeting to form a polygonal structure. Corner braces 18 and spanning braces 20 are used to strengthen the polygonal structure to a desired degree of rigidity. A cover 21 optionally encloses the space within the polygonal structure. In instances when a face 16 is itself not mirrored, at least one such face 16 has a mirror 23 secured thereto. The post structure is secured to a base 22. The base 22 is mounted to a floor or ceiling within a mirror labyrinth by conventional means such that the base 22 is capable of rotation about axis 14. In the simplest embodiment, base 22 has a spindle extending along axis 14 that engages a floor or ceiling mounted bearing race.

In a preferred embodiment, the base 22 engages a motor drive mechanism 26 that is in turn mounted to a floor or ceiling within the mirror labyrinth. The motor drive mechanism 26 includes a diameter ball bearing swivel powered by an electric motor 30. The diameter ball bearing swivel preferably includes holes 32 adapted to receive a fastener 34 maintained in simultaneous contact between the base 22 and the swivel 28. Optionally, the motor drive mechanism 26 has limit switches 32 that are capable of stopping the drive mechanism 26 at any point of a clockwise or counterclockwise movement. A clutch assembly 34 is preferably provided that allows the post 12 to be disengaged from active movement by the drive mechanism 26 upon the post 12 contacting an external obstruction. A drive mechanism 26 operates in a number of modes including continuous rotation within a mirror labyrinth, activated upon an individual coming into proximity thereto through tripping an infrared, pressure or other type of switch; or through a mirror labyrinth operator selectively operating a radiofrequency remote control. It is appreciated that such controls include the ability to rotate either clockwise or counterclockwise.

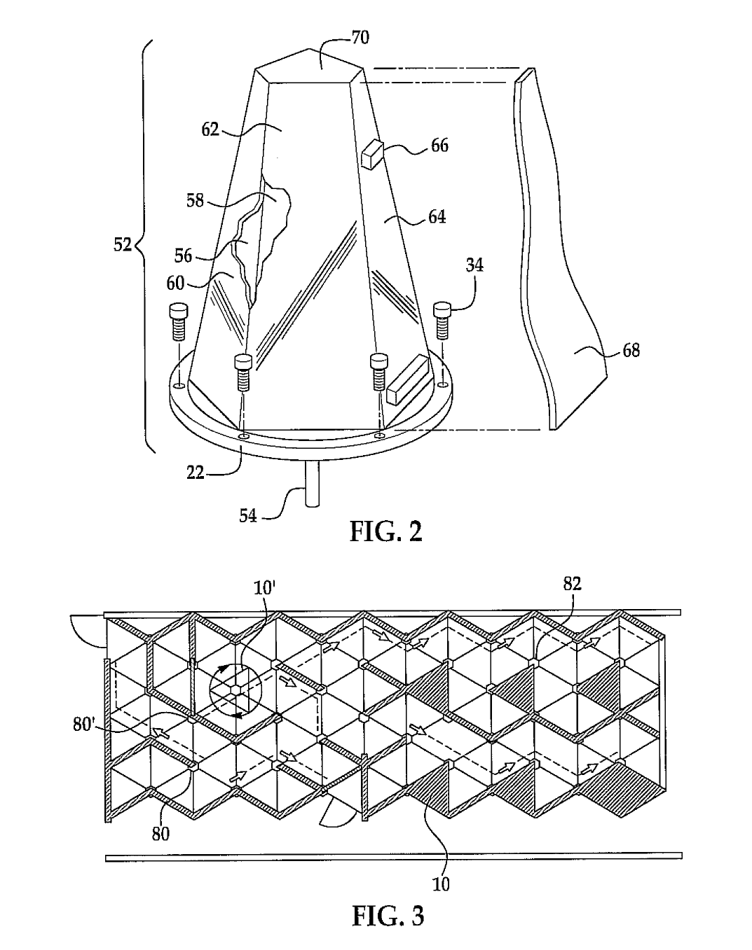

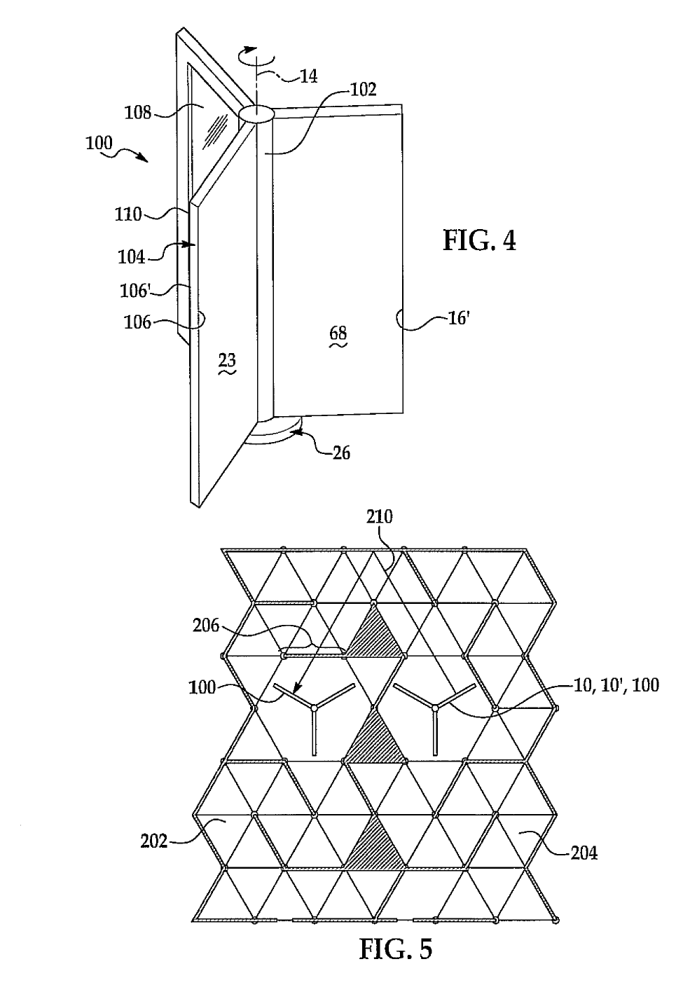

Referring now to FIG. 2, a pentagonal post 52 is shown that represents an alternate embodiment to post 12 depicted in FIG. 1. Post 52 has a base 22 adapted to engage fasteners 34 in instances when post 52 is coupled to a drive mechanism 26 or alternatively includes an axial spindle 54 in instances when the post 52 engages a ceiling or floor mounted bearing race (not shown). The post 52 depicts three faces as showing to the viewer. Planar faces 56 and 58 have mirrors 60 and 62 overlaying these faces, respectively. For visual clarity, the mirrors 60 and 62 are shown in partial cutaway view. Face 64 of the post 52 includes a mounting brace 66 adapted to engage the back side of a nonplanar distorting mirror 68. A cover 70 optionally secures to the opposing terminus of the polygonal structure relative to base 22.

FIG. 3 depicts the placement of an inventive rotatable mirrored stile 10 or 10′ within a mirror labyrinth. Preferably, the stile 10 or 10′ is surrounded by the labyrinth. At least one sensor 80 is present within the mirror labyrinth and is of a type such as infrared, radiofrequency, or pressure switch such that a user coming into proximity to the rotatable mirrored stile 10′ engages the drive mechanism 26 to cause the polygonal post 12 or 52 to rotate about rotational axis 14. Optionally, an additional sensor 82 of a like or dissimilar type relative to sensor 80 is also placed within the mirror labyrinth to provide a separate control switch for changing the operation of the drive mechanism 26. Changes in operation of the drive mechanism illustratively include activation/inactivation, change of drive mechanism directionality, or change in drive mechanism speed. Optionally, a second rotatable mirrored stile is deployed within a mirror labyrinth. The second rotatable mirrored stile is appreciated to be like the rotatable mirrored stile 10 or 10′ or vary in terms of the number of polygonal faces, the number of mirrored polygonal faces or the inclusion or exclusion of a nonplanar distorting mirror mounted thereto. The second rotatable mirrored stile is optionally continually operated or operated by a proximity switch 80′ or triggered by one of the sensors 80 or 82.

An inventive winged rotating mirrored stile is shown generally at 100 where like numerals used in the figures have the same meaning associated with the use of those numerals with respect to the preceding FIGS. 1 and 2. A post 102 is rotatable around a vertical axis 14. The post 102 engages in a simplest embodiment a floor or ceiling mounted bearing race (not shown). Alternatively, a motor drive mechanism 26 is intermediate between the race and post 102 to provide mechanized movement of the post 102.

The post 102 has one to eight wings 104 extending therefrom. Each wing 104 has two opposing faces 106 and 106′. Preferably, the faces 106 and 106′ are substantially parallel. Each face 106 or 106′ of each wing 104 independently supports a planar mirror 23, a distorting mirror 68, contains a transparent glass panel 108, or is painted or otherwise covered to not reflect an image 110. Wings 104 are placed around a pole 102 at a variety of angles relative to one another. It is appreciated that the dimensions of each wing 104 can vary relative to other wings 104 on a stile 100. It is appreciated that in instances when one wishes to enhance the disorienting effects of a labyrinth containing a stile 100, the angles between multiple wings 104 around a post 102 are equivalent and equal to or a multiple of the mirror angles within a labyrinth. By way of example, the stile 100 depicted has inter-wing angles of 120 degrees between the three wings and is particularly well suited for placement within a mirror labyrinth based on an equilateral triangle unit cell. Similarly, four normal winged stile complements are mirror labyrinth based on a cubic unit cell. It is also appreciated that a stile having a wing omitted at a particular position also creates a degree of disorientation. For example a stile 100 having wings 104 at angles 0 degrees-120 degrees and absent a wing 104 present at 240 degrees functions to also be well suited for disorienting a user within an equilateral unit cell based labyrinth. A wing 104 is readily formed of materials conventional to the art including wood, steel, and aluminum.

FIG. 5 depicts the placement of an inventive rotatable winged mirrored stile 100 within a mirror labyrinth. Preferably, the stile 100 is surrounded by the labyrinth to facilitate rotation of the stile 100 and inter-mirror reflection between mirrors mounted on the stile 100 and the surrounding labyrinth. Optionally, at least one sensor 80 is detailed with respect to FIG. 3 coupled to the stile 100 to cause the stile 100 to rotate about the vertical axis 14 in response to a user approaching stile 100. Optionally, an additional sensor 82 of a like or dissimilar type relative to sensor 80, as detailed with respect to FIG. 3, is also placed within the mirror labyrinth to provide a separate control switch for changing operation of a drive mechanism 26, if present on the stile 100. It is appreciated that the disorienting effect created by inventive winged rotating mirrored stile 100 operating in concert with at least one additional stile 100 is such that through multiple inter-mirror reflections, reflections occur between the two stiles 100. It is appreciated that the second stile can vary in the number of wings, as well as whether a planar mirror, distorting mirror, transparent glass panel, or nonreflective coating is applied to a given face of the second stile. The second stile is optionally continually operated or operated by a proximity switch 80′ or triggered by one of the sensors 80 or 82 detailed with respect to FIG. 3. Preferably, a stile 100 is located within a mirror labyrinth proximal to a serpentine or “S-shaped” labyrinth path as depicted at 202 and 204 in FIG. 5. In instances when the mirror labyrinth contains two stiles each independently of the type 10, 10′ or 100, the mirror labyrinth has a dual mirror sided panel 206 that prevents a single reflection interaction between the stiles along the path 210. It is further appreciated that with variation of the lighting scheme in terms of intensity, strobes, and other lighting effects in combination with inventive stile 10 or 10′ or 100, that transiting a mirror labyrinth becomes a particularly complex event that belies the comparatively small area of the mirror labyrinth.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A winged rotatable mirrored stile comprising:
a post mounted to define a vertical rotational axis in a mirror labyrinth, a plurality of wings extending radially from said post, each of said plurality of wings having a wing face, at least one wing face supporting a mirror; and
at least one of said faces being mirrored.

2. The stile of claim 1 further comprising a drive mechanism to rotate said post around the vertical axis assembly to disengage said post from said drive assembly upon said post contacting an external obstruction.

3. The stile of claim 1 wherein said drive mechanism is mounted to said floor within the mirror labyrinth.

4. The stile of claim 1 wherein said plurality of wings is two to six wings.

5. The stile of claim 4 wherein said two to six wings are distributed at equal angles around said post.

6. A mirror labyrinth comprising:
a plurality of fixed position interreflective mirrors; and
a first rotatable mirrored stile sharing reflections with said plurality of fixed position interreflective mirrors.

7. The mirror labyrinth of claim 6 further comprising a sensor activating a drive mechanism rotating said first rotatable mirrored stile upon a person being in proximity to said sensor.

8. The mirror labyrinth of claim 6 further comprising a second rotatable mirrored stile creating interreflections with said rotatable mirrored stile in certain orientations.

9. The mirror labyrinth of claim 6 wherein a portion of said plurality of fixed position interreflective mirrors forms a serpentine S-shaped path adjacent to said first rotatable mirrored stile.

10. The mirror labyrinth of claim 8 wherein at least two inter-mirror reflections of said plurality of fixed position interreflective mirrors separate the interreflection between said second rotatable mirrored stile and said first rotatable mirrored stile.

11. The mirror labyrinth of claim 6 wherein said plurality of fixed position interreflective mirrors have an equilateral triangle unit cell and said first rotatable mirrored stile has an angle of substantially 60 or 120 degrees between mirrored faces of said stile.

12. The mirror labyrinth of claim 6 wherein said plurality of fixed position interreflective mirrors have an equilateral square unit cell and said first rotatable mirrored stile has an angle of substantially 45 or 90 degrees between mirrored faces of said stile.
